(19) United States
(12) Patent Application Publication
(10) Pub. No.: US 2004/0130844 A1
(43) Pub. Date: Jul. 8, 2004

(54) Zinc oxide electric device and manufacturing method thereof

(76) Inventors: Liann-Be Chang, Hsinchu (TW); Wey-Ping Yu, Hsinchu (TW); Hai Lan, Hsinchu (TW); Ching-Chwan Pan, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/739,162

(22) Filed: Dec. 19, 2003

(30) Foreign Application Priority Data
Dec. 23, 2002 (TW) 91137388

(51) Int. Cl. H02H 1/00

(52) U.S. Cl. 361/118

(57) ABSTRACT

The claimed invention discloses a nanometer-class ZnO electric device and a manufacture method thereof. The manufacture method includes sintering by pure nanometer-class ZnO powders, sintering by nanometer-class and general ZnO powders, and sintering by ground ZnO powders. The claimed ZnO electric device has advantages of a higher breakdown voltage, a lower leakage current, and a larger surge current, and can be applied to kinds of electric surge protection circuits.

### BACKGROUND OF INVENTION

1. Field of the Invention

The invention relates to a ZnO electric device and a manufacture method thereof, and more particularly, to a nanometer-class ZnO electric device and a manufacture method thereof.

2. Description of the Prior Art

The electromagnetic pulse and the electromagnetic interference always exist in the nature, such as lightning or sunspots, and make troubles to the communication and information equipments. The communication and information equipments play an important role for commanding, controlling and communicating in many fields, especially in a war, so a human-made electromagnetic interference or destruction is taken seriously. The invasion of an electromagnetic wave is passing through the construction or following along the piping lines. A powerful electromagnetic wave (said electromagnetic pulse) will induce a surge to burn down the communication and information equipments. The electromagnetic pulse is sorted to several types: the Nuclear Electromagnetic Pulse (NEMP), the Lightning Electromagnetic Pulse (LEMP) and the High Altitude Electromagnetic Pulse (HEMP). The NEMP is an electromagnetic pulse formed by a nuclear explosion. Since the wide influence of the nuclear explosion, it is supervised by the public voice over the world and can only be a strategic weapon, and some countries develop the HEMP bombs carried by long distance missiles recently. The HEMP bomb damages a small area while exploding and can destroy the communication and information equipments without killing the enemy. It is required for all countries probably attacked by the HEMP bomb to actively research in the surge protection.

In addition, quality of the electric power is getting inferior. Because using of some high-frequency apparatus or switching power supply device, or turning on a high power machine, there are many surges in the general electric power, called the instantaneous over-voltage or over-current. The instantaneous over-voltage or over-current always damages the electric devices.

Furthermore, as the electric circuit makes progress from the vacuum tube to the small-scale integration (SSI), large-scale integration (LSI) and very large-scale integration (VLSI), the size of an electric device is reduced to 0.25 micrometers, even to 0.13 micrometers. After the devices being integrated, an advantage of fast operating speed is obtained, but some disadvantages also appear. As the distance between two devices becomes shorter, the sustainable voltage between them is lower (electric field intensity=voltage/distance). The sustainable surge, over-voltage or over-current of the vacuum tube devices may damage the VLSI devices. An important research is using a surge-restraining device at the input terminal of these electric devices, and conducting it to ground after the surge exceeds a threshold voltage.

Besides the over-voltage or over-current of the electric power, the electrostatic charge formed by the surrounding also makes problems. While the scale of devices reducing, its capacitance also reduces linearly (device capacitance=dielectric constant×superficial measure÷distance). Although the charge formed by the surrounding is almost a constant, as the capacitance reduces with device's scale, the electrostatic voltage will increase (electrostatic charge Q=capacitance×voltage). The high electrostatic voltage may puncture the dielectric layers of the semiconductor and lead to the leakage current.

Using a ZnO electric device can prevent the damage of the electrostatic charge. The ZnO electric device is a suitable surge protection device for the pad of the power terminal or the input/output terminal. The ZnO electric device is a resistor sintered with the ZnO powders in a high temperature. It has a characteristic that the resistor of the device is instantaneously reduced to conduct while the voltage difference in two ends exceeds a predetermined value. FIG. 1 shows a characteristic of a general ZnO electric device. When normally operating, the ZnO electric device works as a resistor with high resistance, and when the voltage exceeds a positive/negative value, it works as a resistor with very low resistance and is conducted immediately. After the device is conducted, the conducted current is instantaneously risen and instantly grounded. Thus, the exceeding voltage won't damage any circuit because of the characteristics of the ZnO electric device. So the ZnO electric device is suitable for a surge protection circuit.

However, the main problem is the ZnO electric device is a two terminals device, which is layered an insulating material. When un-conducting, it is not only a resistor with high resistance but also a capacitor with high capacitance. The capacitance at the input/output terminal may induce an insertion loss of signals that will dissipate the signals from an antenna terminal or an external terminal and worsen the signal reception. If the cross-sectional surface of the ZnO electric device is reduced, the capacitance of the ZnO electric device will be also reduced, but the ZnO electric device may fail to ground the over-voltage or over-current.

### SUMMARY OF INVENTION

It is therefore a primary objective of the claimed invention to provide a ZnO electric device and a manufacture method thereof to solve the above-mentioned problem. The claimed invention sinters the nanometer-class ZnO powders to form a ZnO electric device, and enhances the capability of current leakage of the ZnO electric device for improving the effect of surge protection.

The claimed invention utilizes a conventional nanometer-class technology to refine the ZnO ceramic powders and forms the nanometer-class pure ZnO powders. The diameter of the nanometer-class ZnO powder is less than 100 nanometers and prefers less than 50 nanometers. The ZnO electric device sintered by the nanometer-class ZnO powder or mixed with the general ZnO powder has a better characteristic than the prior one.

The small size of the ZnO powder increases the effective surface of the ZnO electric device. As the effective surface increasing, the conductive path is also increased and leads to a larger conductive current or surge current and a lower conductive resistance.

In addition, the small powder can produce a uniform material. The breakdown voltages in the uniform material are more uniform while the electric field rising. The uniform material can prevent the electric device from unexpected breakdown and appropriately improve its reverse breakdown voltage.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a current-voltage (I-V) characteristic diagram of a general ZnO electric device.

FIGS. 2A-2C is characteristic diagrams of a ZnO electric device sintered by 100 nanometer-class ZnO powders.

FIGS. 3A-3C is characteristic diagrams of a ZnO electric device sintered by micrometer-class ZnO powders mixed with 40 nanometer-class ZnO powders.

FIGS. 4A-4C is characteristic diagrams of a ZnO electric device in which the ZnO powders comes from the micrometer-class ZnO powders after at least one grind process.

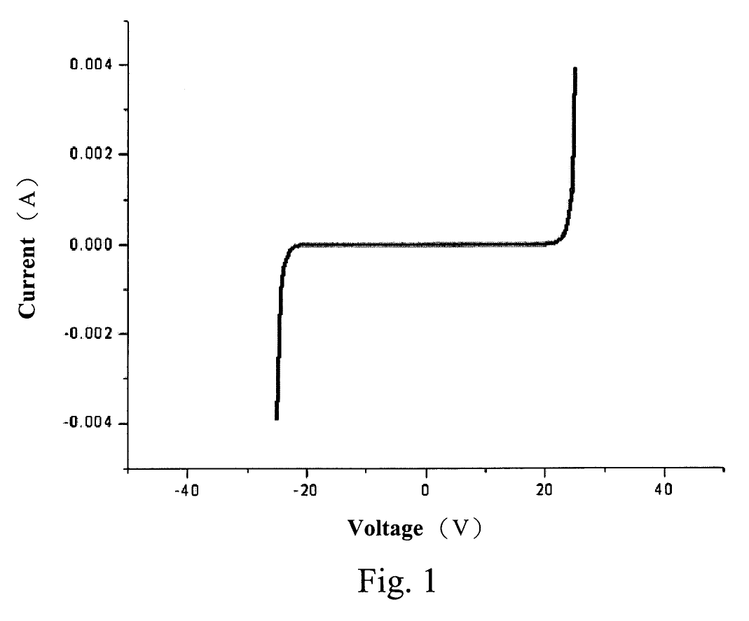

### DETAILED DESCRIPTION

For proving the feasibility of the claimed invention, many experiments are practiced. The ZnO powders in different diameters, such as pure 100 nanometers powder or smaller than 50 nanometers powder (40 nanometer-class) mixed with the conventional ZnO micrometer-class powders or the reworked ZnO powders, are sintered in different temperatures. The result is compared with that of a conventional ZnO device. Under normal condition (without electromagnetic pulse or surge), the leakage current of a nanometer-class ZnO device has a direct proportion to the size of powder and has an inverse proportion to the breakdown voltage. When the operating voltage exceeds a value, the nanometer-class ZnO device will be conducted (like a resistor with low resistance), and induce a larger surge current to ground.

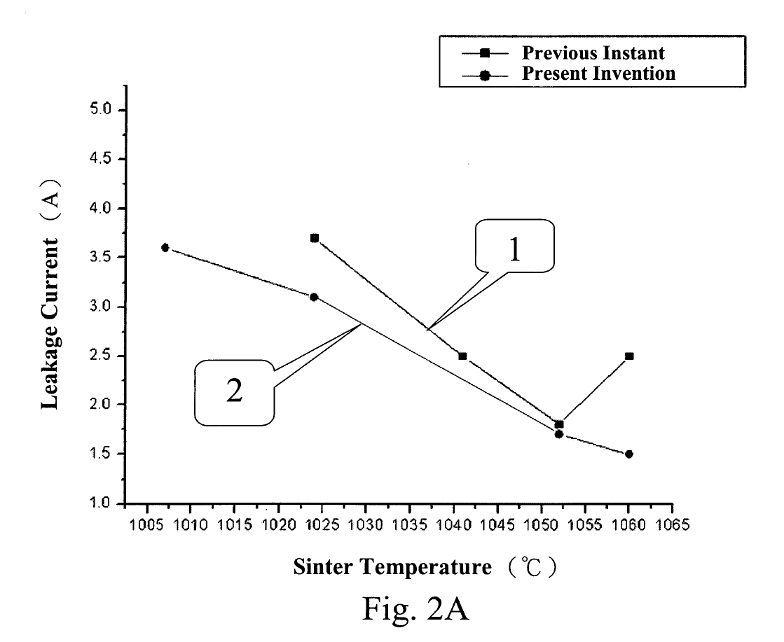

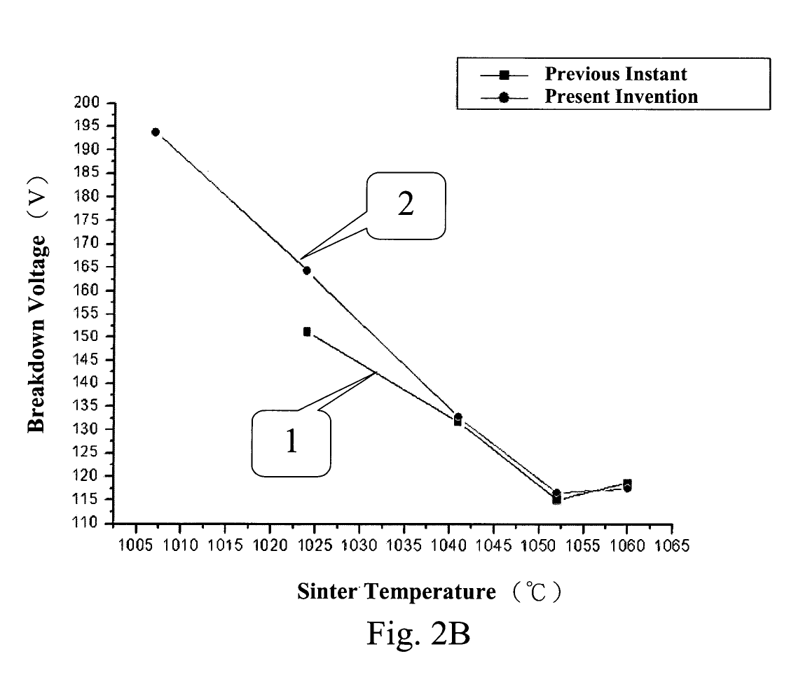

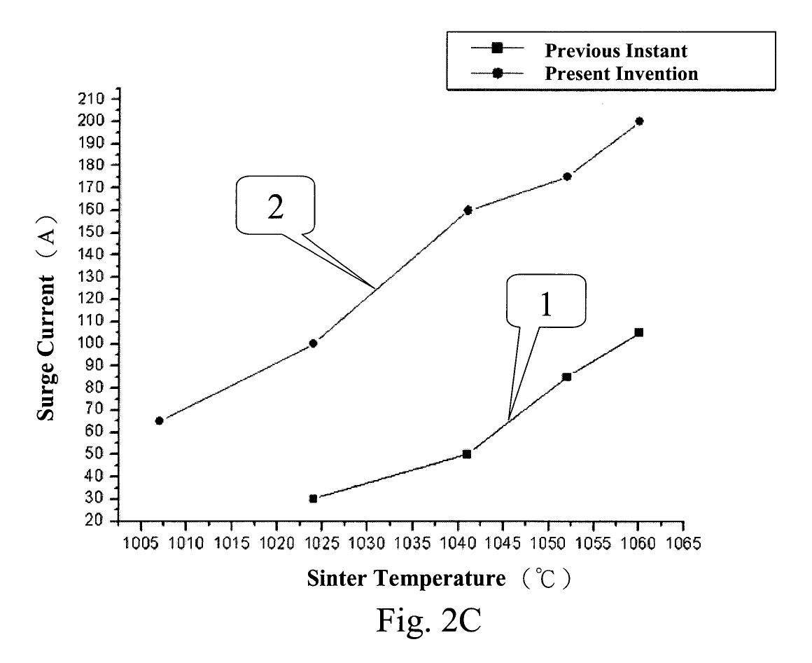

In the first embodiment, the ZnO electric device is sintered by 100 nanometer-class powders in 800° C. FIG. 2A is a diagram of a ZnO electric device sintered by pure nanometer-class powders compared with a conventional ZnO electric device. In any sintering temperature, the leakage current of the ZnO electric device sintered by pure nanometer-class powders (curve 2) is lower than that of the conventional ZnO electric device (curve 1), and is effectively lowered to less than 1.5 microampere. As FIG. 2B shows, the breakdown voltage of the claimed invention (curve 2) is higher than that of the prior device (curve 1) in a same sintering temperature. In addition, as FIG. 2C shows, the surge current of the ZnO electric device sintered by pure nanometer-class powders (curve 2) is higher than that of the prior device when an over-voltage surge appears. Under the situation of an external 1000V voltage, the maximum surge current of the conventional ZnO electric device is 100A, and that of a ZnO electric device sintered by pure nanometer-class powders is 210A.

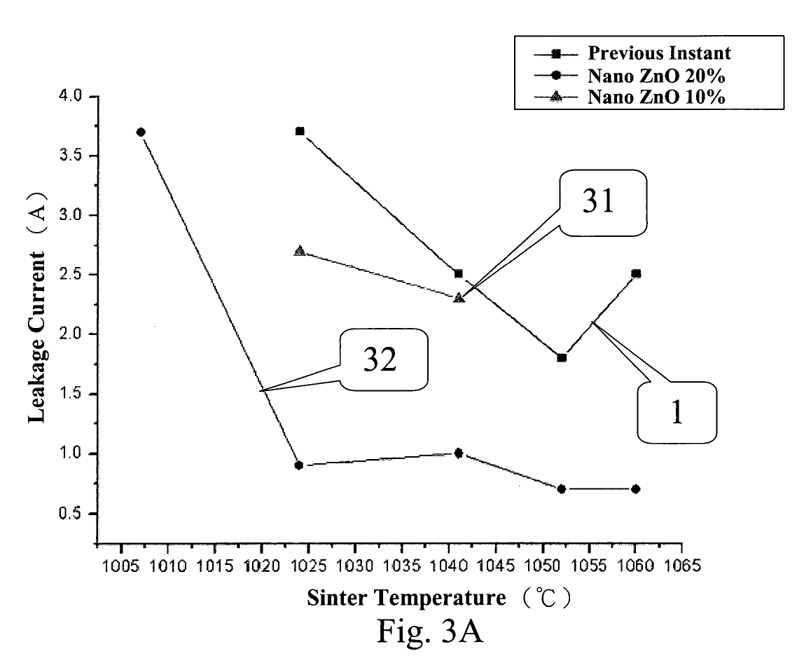

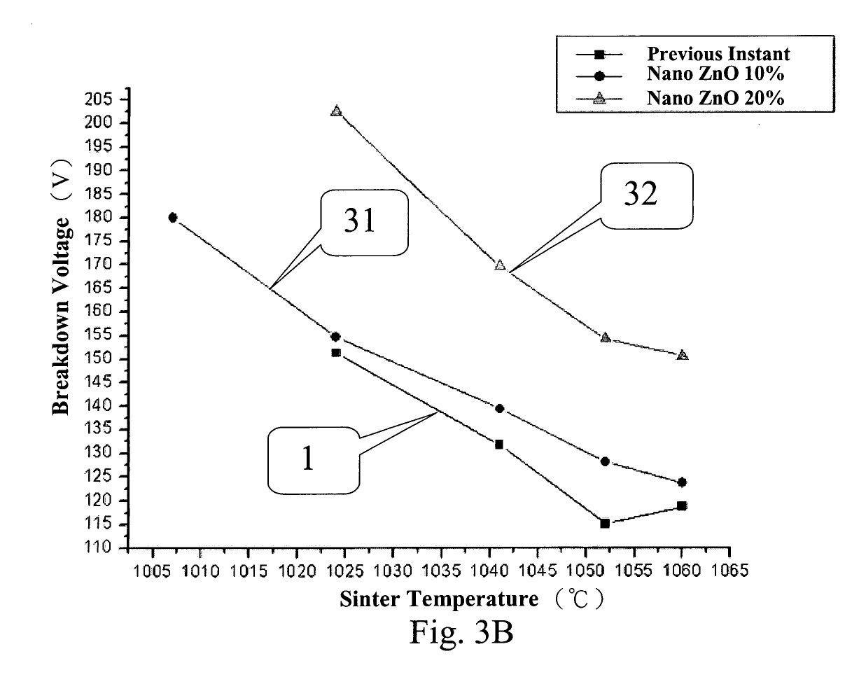

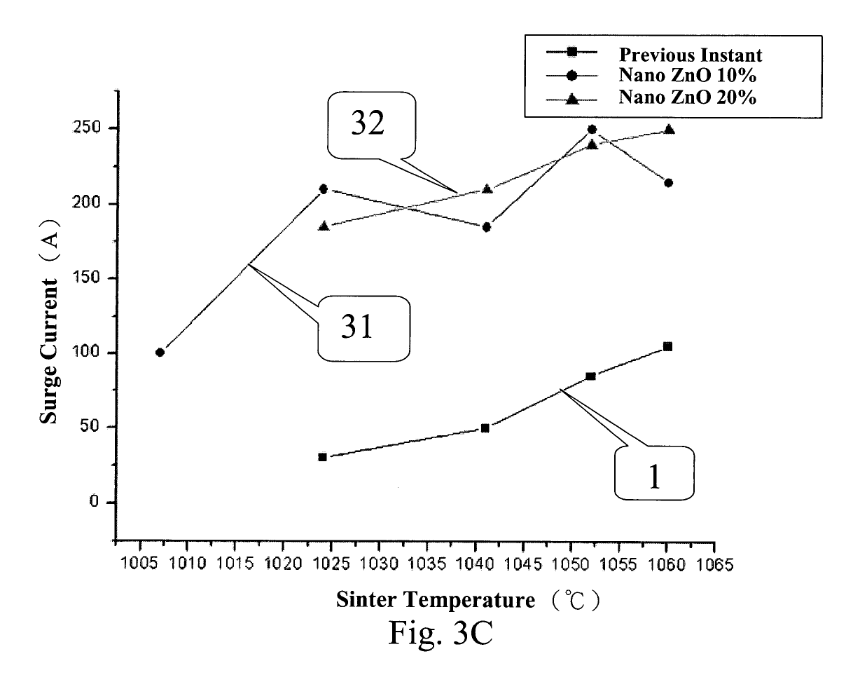

In the second embodiment, the conventional ZnO powders are sintered with the nanometer-class ZnO powders (the weight percentage is more than 10%), and the characteristic of the ZnO electric device is noticeably improved, including increasing the surge current and decreasing the leakage current. Please refer to FIG. 3A, in which curve 31 and curve 32 show characteristics of a ZnO electric device sintered by the conventional ZnO powders mixed with the 40 nanometer-class ZnO powders. The curve 31 shows the weight percentage of the nanometer-class ZnO powder is 10%, and the curve 32 shows the weight percentage of the nanometer-class ZnO powders is 20%. No matter curve 31 or 32, the leakage current is less than that of the prior device (curve 1) in the same sintering temperature, and is lowered to 0.7 mA (curve 32). As FIG. 3B shows, the breakdown voltage of the claimed invention (curve 31, 32) is higher than that of the prior device in the same sintering temperature, and is raised to 205V (curve 32). Furthermore, the surge current of the claimed invention (curve 31,32) is higher than that of the prior device when an over-voltage surge appears. Under the situation of an external 1000V voltage, the maximum surge current of the claimed invention can be increased to 240A.

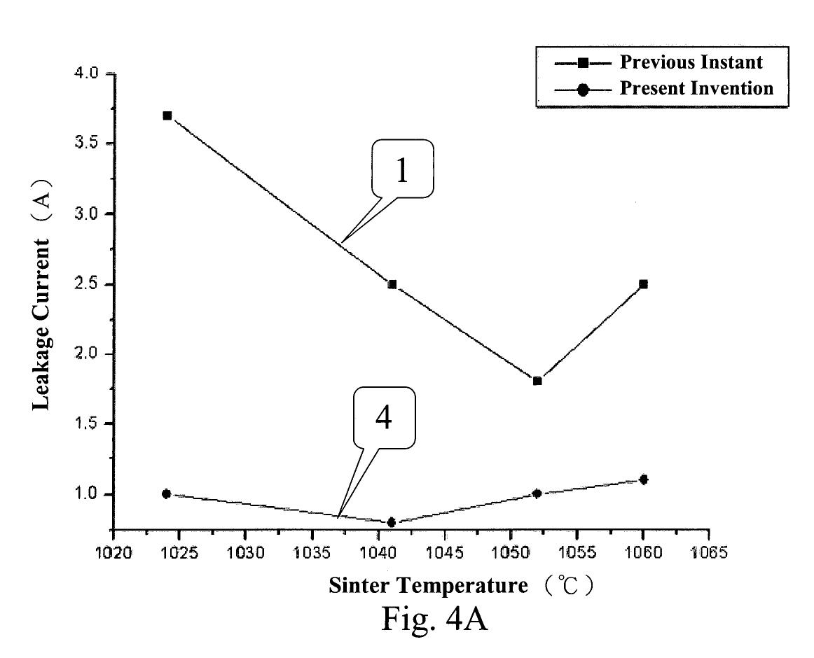

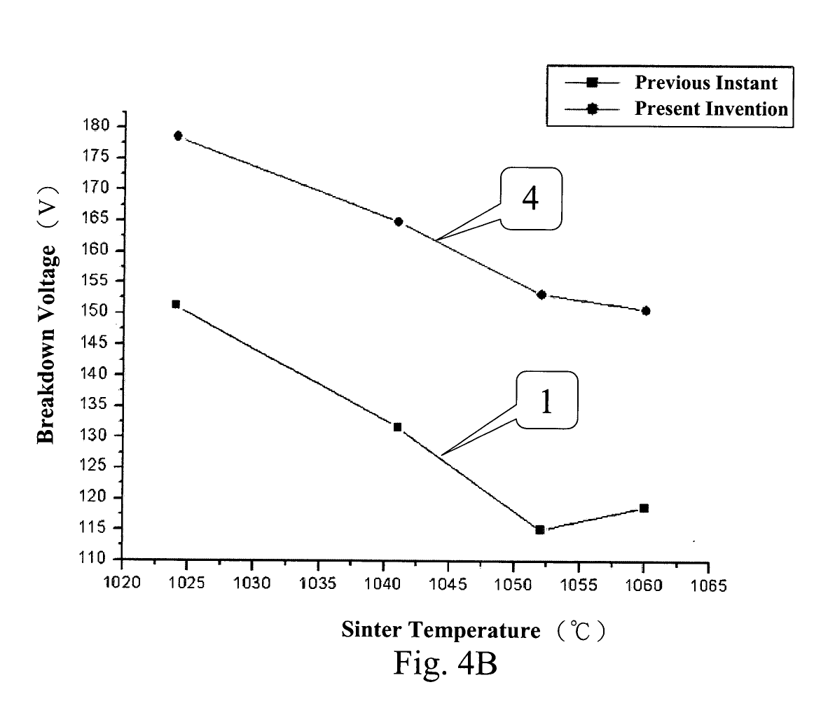

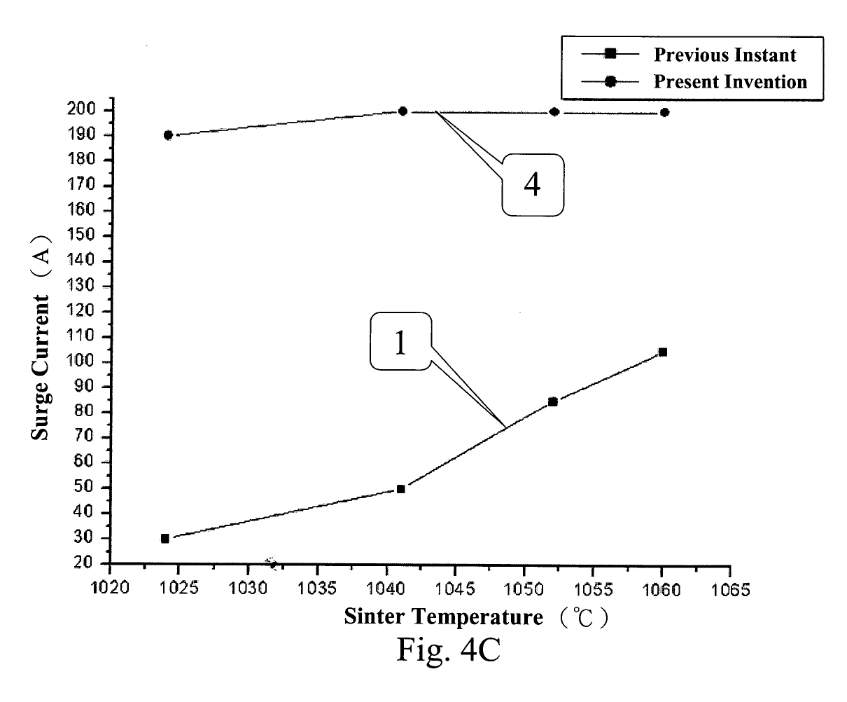

The claimed invention further provides another manufacture method of the ZnO electric device. The grinding method is used for ZnO powders, and part of the ZnO powders is ground into nanometer-class. This kind of ZnO powders also has the same effect for increasing the surge current after being sintered. Please refer to FIG. 4A, in which curve 4 shows a ZnO electric device sintered by the ground powders. The leakage current of the claimed invention (curve 4) is less than that of the prior device (curve 1) in the same sintering temperature, and is lowered to 0.2 mA. As FIG. 4B shows, the breakdown voltage of the claimed invention (curve 4) is higher than that of the prior device in the same sintering temperature. As FIG. 4C shows, the surge current of the claimed invention (curve 4) is higher than that of the prior device when an over-voltage surge appears. Under the situation of an external 1000V voltage, the maximum surge current of the claimed invention can be increased to 195A, which is obviously larger than that of the prior device, 100A.

In contrast to the prior art, the present invention discloses three manufacture methods of the ZnO powders and the ZnO electric device. The first method is using the pure ZnO powders smaller than 100 nanometers to sinter to a ZnO electric device. The second method is using the 10% upward mixed nanometer-class ZnO powders (added the nanometer-class ZnO powders into the conventional powders) to sinter to a ZnO electric device. The third method is grinding the conventional ZnO powders and sintering in temperature more than 1000° C. If the sintering temperature is higher than 1000° C., the sintered ZnO electric device will have the surge current increased and the leakage current decreased. In addition, the claimed ZnO electric device can be applied to various protection circuits, such as electromagnetic pulse protection circuit, electrostatic discharge protection circuit, electric surge protection circuit, and lightning strike protection circuit. The claimed ZnO electric device can be further utilized with a gas discharge tube to be a second stage protection device of the lightning strike protection circuit, or utilized with a semiconductor electrostatic discharge protection circuit to be a first stage protection device of the electrostatic discharge protection circuit.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A zinc oxide (ZnO) electric device is sintered by a plurality of nanometer-class ZnO powders, and a diameter of the nanometer-class ZnO powder is less than 100 nanometers.

2. The ZnO electric device of claim 1 can be further added a general ZnO powder to sinter.

3. The ZnO electric device of claim 2 wherein a weight percentage of the nanometer-class ZnO powder in a total ZnO power is more than 10%.

4. The ZnO electric device of claim 1 can be utilized to an electromagnetic pulse protection circuit.

5. The ZnO electric device of claim 1 can be utilized to an electrostatic discharge protection circuit.

6. The ZnO electric device of claim 1 can be utilized to an electric surge protection circuit.

7. The ZnO electric device of claim 1 can be utilized to a lightning strike protection circuit.

8. The ZnO electric device of claim 1 can be utilized with a gasdischarge tube to be a second stage protection device of the lightning strike protection circuit.

9. The ZnO electric device of claim 1 can be utilized with a semiconductor electrostatic discharge protection circuit to be a first stage protection device of the electrostatic discharge protection circuit.

10. A manufacture method of a ZnO electric device, the method is sintering a plurality of nanometer-class ZnO powers in temperature 800° C. to 1200° C. to obtain the ZnO electric device, and diameter of the nanometer-class ZnO powder is less than 100 nanometers.

11. A manufacture method of a ZnO electric device, the method is sintering a plurality of nanometer-class ZnO powers and a plurality of general ZnO powders to obtain the ZnO electric device, and a diameter of the nanometer-class ZnO powder is less than 100 nanometers.

12. The method of claim 11 wherein a weight percentage of the nanometer-class ZnO powder in a total ZnO power is more than 10%.

13. The method of claim 11 wherein the diameter of the nanometer-class ZnO powder prefers to be smaller than 50 nanometers.

14. A manufacture method for reprocessing a ZnO electric device, the method is sintering a plurality of ZnO powders contained in a conventional ZnO electric device after at least one grind process.

15. The method of claim 14 wherein the ZnO powder can form a nanometer-class ZnO powder after the grind process, and a weight percentage of the nanometer-class ZnO powder in the total ZnO power is more than 10%.

16. The method of claim 15 wherein a diameter of the nanometer-class ZnO powder is less than 100 nanometers.

17. The method of claim 15 wherein a diameter of the nanometer-class ZnO powder is less than 50 nanometers.
